(19) United States
(12) Patent Application Publication
(10) Pub. No.: US 2011/0137585 A1
(43) Pub. Date: Jun. 9, 2011

(54) METHOD AND APPARATUS FOR MEASURING THE PHASE CHANGE OF A SOUND WAVE PROPAGATING THROUGH A CONDUIT

(76) Inventor: KENNETH CHARLES McGILL, SR., Milledgeville, GA (US)

(21) Appl. No.: 12/632,545

(22) Filed: Dec. 7, 2009

(51) Int. Cl. G01N 29/07; G06G 7/48

(52) U.S. Cl. 702/56; 73/597; 703/9

(57) ABSTRACT

A system for measuring the superposition of a plurality of sound waves propagating within a conduit containing a fluid having a plurality of transducers positioned substantially parallel to the flow direction along the external surface of the conduit. The system includes means for modeling the superposition of a plurality of sound waves as they propagate within the conduit.

### FIELD OF THE INVENTION

This invention relates to a system and method for measuring the phases of sound waves. More specifically, this invention relates to a system and method for measuring the superposition of multiple sound waves as they propagate through a fluid within a conduit.

### BACKGROUND OF THE INVENTION

The phase change of a sound wave detected by transducers during propagation of the sound wave through a conduit containing fluid can be modeled by the following equation:

Ψ=e^{[2π if(t±x/c′)]} or e^{[ω(t±x/c′)]},

where Ψ is the phase of the sound wave, f is the frequency of the sound wave, t is the time since generation of the sound wave, and x is the separation of the transducers in various arrangements. The variable c′ is the speed of the propagated sound wave and depends upon the direction of fluid flow with respect to the source of the wave.

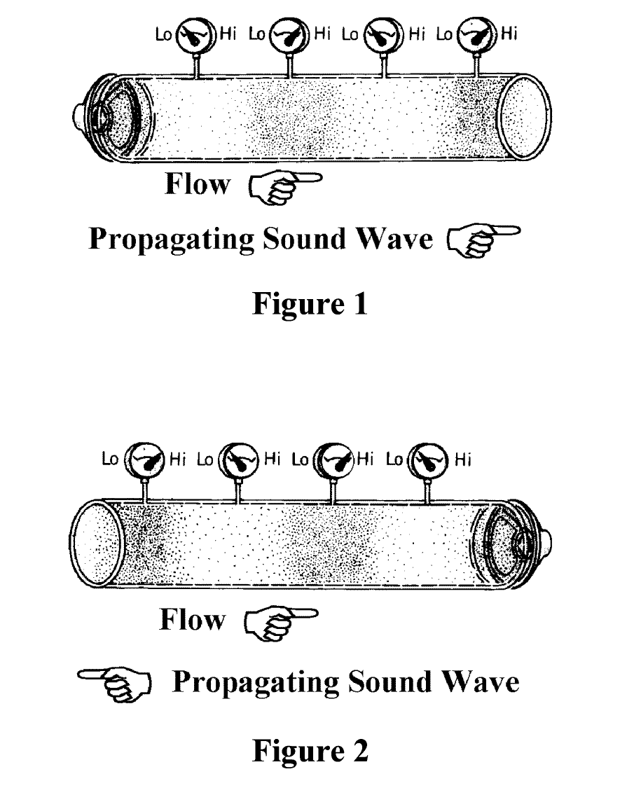

For a fluid that flows from left to right, if the propagation of the sound wave is also from left to right as depicted in FIG. 1, then the detected sound wave can be modeled by:

$${Ψ}_{LR} = {e}^{[ ω ( t - \frac{x}{c + v} ) ]} ,$$

where c is the speed of sound in the fluid and v is the velocity of fluid flow.

If the propagation of the sound wave is from right to left as depicted in FIG. 2, then the detected sound wave can be modeled by:

$${Ψ}_{LR} = {e}^{[ ω ( t + \frac{x}{c - v} ) ]} .$$

Currently known methods for measuring phases of sound waves are not capable of simultaneously measuring wave forms traveling in opposite directions through the fluid within the conduit. Thus, using current methods of measuring phases of sound waves, a single-dimension measurement in spatial component x yields only one measurement of phase for a wave resulting from the superposition of two or more propagating waves. For example, if one tries to detect a wave with a single transducer from two sources placed up stream and down stream of a reference point on the conduit, the detected wave will be a single wave that is the superposition of the two waves. Therefore, any phase measurement based on a single spatial component will yield a result that is corrupted by sound from any other source of the same frequency. In addition to interference from other sound waves, the phase measurement can be also be corrupted by the source of the very wave being measured as the wave reflects off of the walls of the conduit.

In a conduit that contains fluid flowing at a very high velocity, the noise generated by the fluid itself can also corrupt the phase measurement. To approximate the amount of noise required to corrupt a phase measurement, consider the wave shown below:

$$Ψ = cos ( 2 π f ( t - \frac{x}{c + v} ) ) + 0.01 sin ( 2 π f ( t - \frac{x}{c + v} ) ) .$$

In the above equation, a first wave is represented by cos(2πf(t−(x/c+v))), while a second wave is represented by 0.01 sin(2πf(t−(x/c+v))). Thus, the second wave, which is generated from the same source as the first wave, is 90 degrees out of phase compared to the first wave and has amplitude equal to 1% the amplitude of the first wave. Due to the presence of the second wave, the resulting wave would have a difference in phase of 0.57 degrees=tan⁻¹(0.01) or 0.16% full scale. Therefore, assuming a speed of sound (c) of 350 m/s, this difference in phase translates into an error of about 0.56 m/s. Given a full range of flow velocity of 0 m/s to 10 m/s, the difference in phase translates into about a 5.6% error in flow velocity.

The magnitude of one percent relative amplitude is more clearly described when converted to decibels. Given that the intensity (I) of a sound wave is proportional to the square of the waves' amplitude (A), then

$$\frac{I}{{I}_{O}} = {( \frac{Δ A}{A} )}^{2} = 0.0001 , \\ or$$

$$β = 10 log ( \frac{I}{{I}_{O}} ) = - 40 dB .$$

Thus, even though the amplitude of the second wave is only 1% the amplitude of the first wave, the presence of the second wave is enough to cause 40 dB of noise, which can interfere with the phase measurement. Accordingly, it is unreasonable to assume that known techniques for phase measurement can accurately model the phases of individual waveforms that are subject to interference from other waveforms.

Experimentally, when a sound source is placed up-flow in an air flow conduit and a single-frequency sound wave is sent propagating through the conduit in the same direction as the air flow, the phase of the propagating wave form can be calculated by employing a fast Fourier Transform of each of the individual time domain signals.

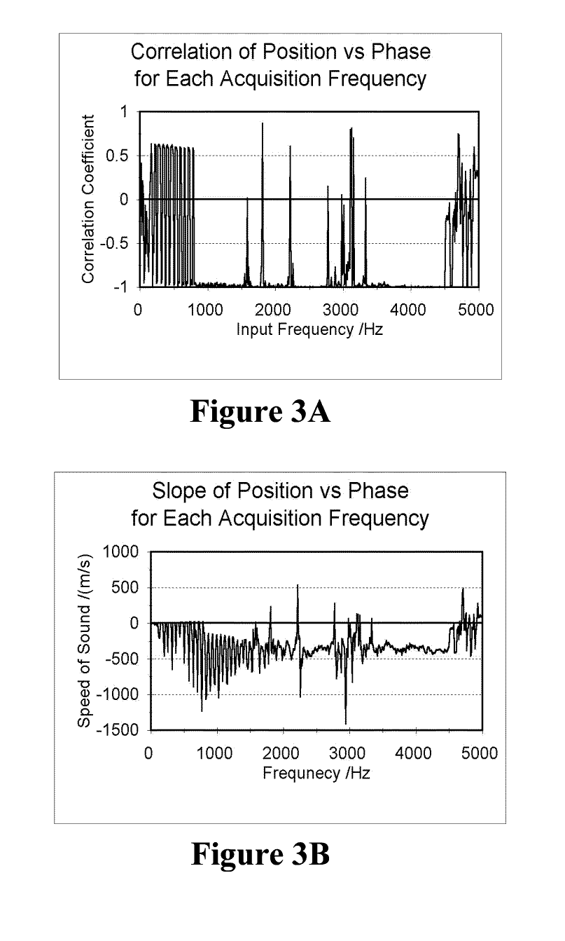

In one previous experiment, eight time domain wave forms were simultaneously acquired by eight transducers at different positions along the conduit. Each transducer was spaced from adjacent transducer by 0.200 inches. This experiment was then repeated for 512 different frequencies over a domain of 0 Hz to 5000 Hz. The results of a linear regression of the position versus phase measured on each transducer are depicted in FIGS. 3 and 3A. The expected phase can be modeled by the following equations:

$$Phase = - x \frac{2 π f}{v + c}$$

$$x = - ( v + c ) ( \frac{phase}{2 π f} )$$

Therefore, a linear regression of position (x) versus the reduced phase (phase/(2πf)) should yield a slope that is equal to −(v+c).

As demonstrated by FIGS. 3A and 3B, the resonance behavior at the lower frequencies corresponds to longitudinal resonance within the conduit. Additionally, within the frequency range from 3500 Hz to approximately 4500 Hz, the slope of the position versus phase curve oscillates around the speed of sound of the fluid within the conduit. Although these results seem to indicate that the measurements were influenced by noise and were of poor quality, inspection of the correlation coefficient indicates that the measurement has extremely good correlation, with an average correlation coefficient within the frequency range of approximately −0.999. These results suggest that ambient sound is interfering with the results and creating a resultant waveform that has a phase that is dependent upon the relative positions of the source. However, there are no known techniques that have allowed for accurate modeling of sound waves resulting from the superposition of multiple waveforms within a conduit. In fact, many attempts to cross-correlate phase measurements of sound waves propagating within a conduit have failed as a result of an inability to model the individual sound waves that are superposed to produce the resultant waveform. For example, previous attempts have been unable to distinguish ambient noise from the sound waves traveling within the conduit.

Thus, there is a need in the pertinent art for a system and method that are capable of accurately measuring the velocity of fluid flow and the speed of sound within a conduit. Additionally, there is a need in the pertinent art for a system and method that are capable of modeling the phases of sound waves propagating through a fluid within a conduit. Further, there is a need in the pertinent art for a system and method that are capable of modeling the superposition of multiple sound waves as they propagate through a fluid within a conduit.

### SUMMARY

In one embodiment, the invention comprises a system for measuring the superposition of a plurality of sound waves propagating within a conduit containing a fluid. In this embodiment, the conduit has an external surface, and the fluid flows through the conduit in a flow direction. In one aspect, the plurality of sound waves consists of at least two sound waves.

In one aspect, the system for measuring the superposition of the plurality of sound waves includes a plurality of transducers positioned substantially parallel to the flow direction along the external surface of the conduit. In an additional aspect, the system for measuring the superposition of the plurality of sound waves includes means for modeling the superposition of the plurality of sound waves as they propagate within the conduit.

In a further aspect, the means for modeling the superposition of the plurality of sound waves is configured to receive a data set from each transducer indicative of the velocity of fluid flow through the conduit and the speed at which the sound waves propagate through the fluid. Upon storage of a selected number of data sets, the means for modeling the superposition of the plurality of sound waves is configured to process an array of data sets to produce a model of the superposition of the plurality of sound waves as they propagate within the conduit. In one aspect, the means for modeling the superposition of the plurality of sound waves processes the array of data sets by performing a two-dimensional fast Fourier transform on the array of data sets. In this aspect, the means for modeling the superposition of the plurality of sound waves can use the results of the two-dimensional fast Fourier transform to produce a wave equation that models the superposition of the plurality of sound waves.

### DETAILED DESCRIPTION OF THE FIGURES

These and other features of the preferred embodiments of the invention will become more apparent in the detailed description in which reference is made to the appended drawings wherein:

FIG. 1 is a perspective view of a prior art system for measuring the phase change of a sound wave propagating through a fluid within a conduit in the direction of fluid flow.

FIG. 2 is a perspective view of a prior art system for measuring the phase change of a sound wave propagating through a fluid within a conduit opposite the direction of fluid flow.

FIG. 3A is a graph of the correlation of position vs. phase for each acquisition frequency used to generate a sound wave during a known experimental technique for measuring the phase changes of sound waves propagating through a fluid within a conduit.

FIG. 3B is a graph of the slope of position vs. phase for each acquisition frequency used to generate a sound wave during a known experimental technique for measuring the phase changes of sound waves propagating through a fluid within a conduit.

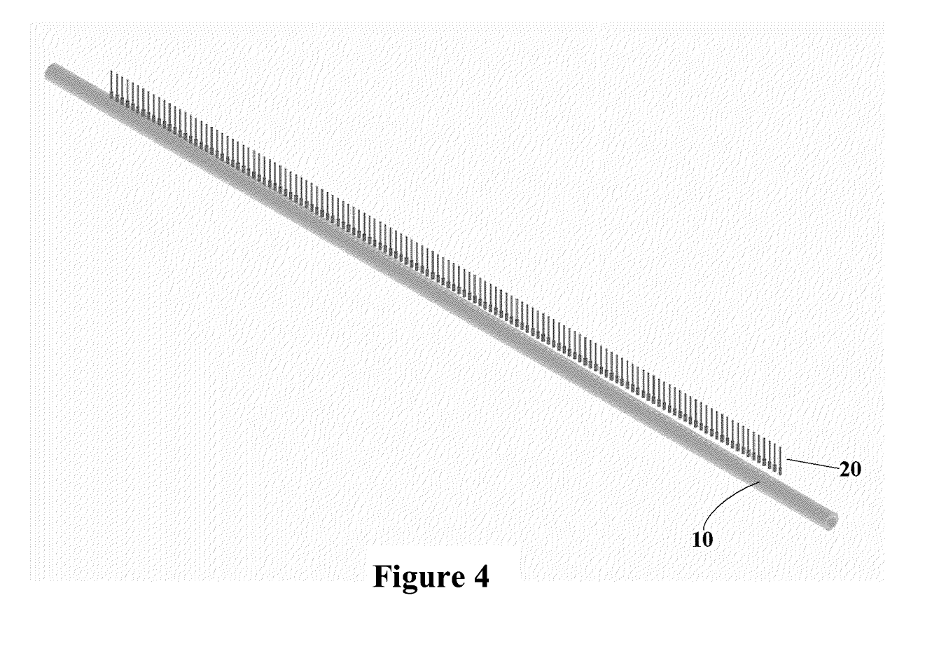

FIG. 4 is a perspective view of the plurality of transducers positioned along the external surface of the conduit, as described herein.

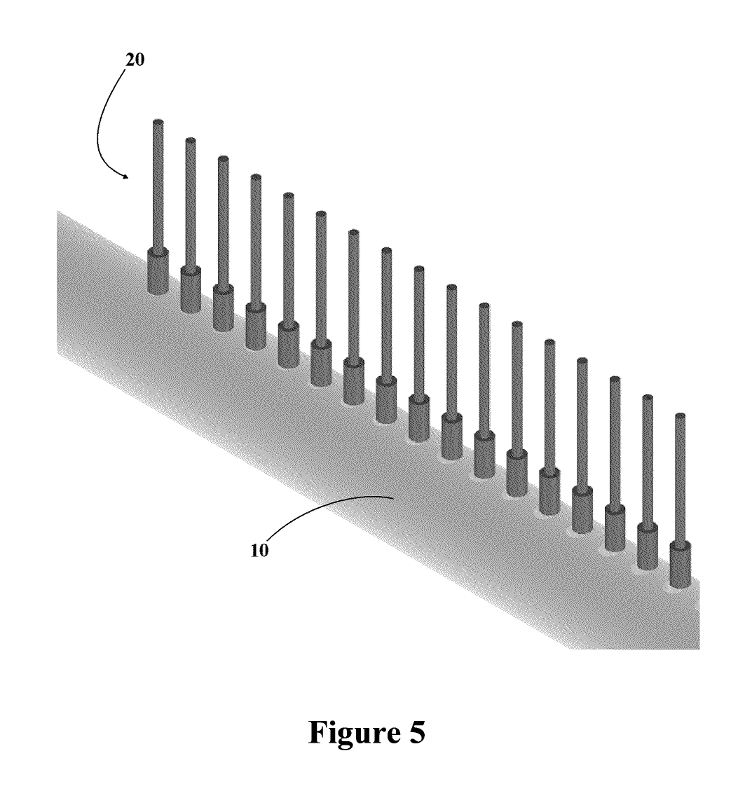

FIG. 5 is an enlarged perspective view of the plurality of transducers positioned along the external surface of the conduit, as described herein.

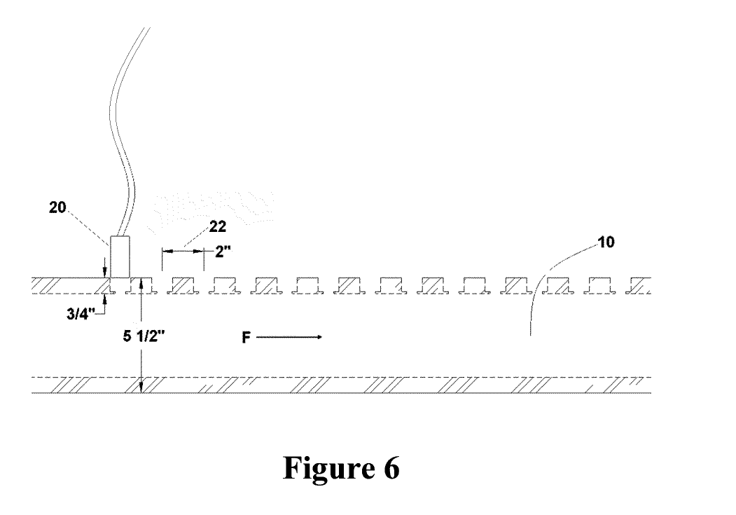

FIG. 6 is a cross-sectional side view of the conduit depicting the separation between respective transducers of the plurality of transducers.

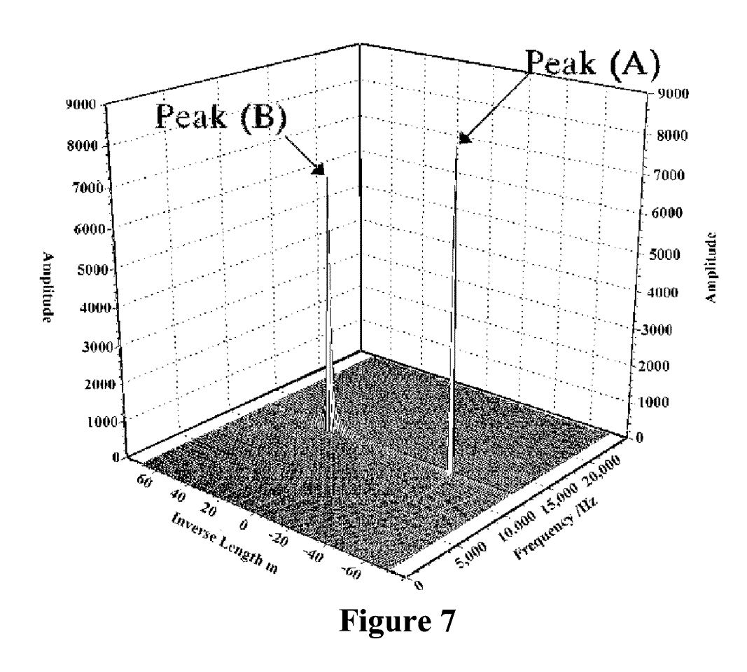

FIG. 7 is a three-dimensional graph of the two-dimensional fast Fourier transform performed as described herein on a wave equation of the form:

$${Ψ}_{s} ( t , x ) = A {e}^{[ ω t - \frac{ω}{c + v} x ]} + B {e}^{[ ω t + \frac{ω}{c - v} x ]} .$$

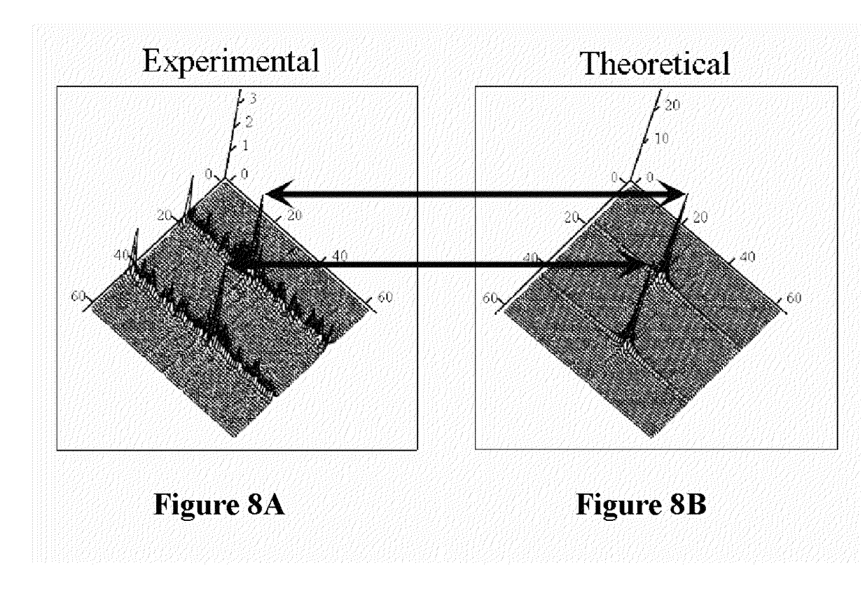

FIG. 8A is a three-dimensional graph of the two-dimensional fast Fourier transform performed on a wave equation produced based on experimental processing of two sound waves propagating through a fluid within a conduit.

FIG. 8B is a three-dimensional graph of the two-dimensional fast Fourier transform performed on a theoretical wave equation for the sound waves of FIG. 8A.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a tube” can include two or more such tubes unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

In one embodiment, and with reference to FIGS. 4-6, a system for measuring the superposition of a plurality of sound waves propagating therein a conduit 10 containing a fluid is described. In this embodiment, and as depicted in FIG. 6, the conduit 10 can have an external surface, and the fluid can flow therethrough the conduit in a flow direction F. In one aspect, the plurality of sound waves can comprise two sound waves.

In one aspect, the system for measuring the superposition of the plurality of sound waves can comprise a means for generating the plurality of sound waves. In this aspect, the means for generating the plurality of sound waves can comprise any means commonly known in the art for producing a sound wave within a fluid, such as, for example and without limitation, at least one speaker or other vibratory device. However, as one having ordinary skill in the art will appreciate, it is contemplated that the one or more sound waves of the plurality of sound waves can be generated by the fluid flowing therethrough the conduit. It is further contemplated that the plurality of sound waves can include sound waves resulting from random or ambient sound.

In another aspect, the system for measuring the superposition of the plurality of sound waves can comprise a plurality of transducers 20 positioned substantially parallel to the flow direction along at least a portion of the external surface of the conduit 10. It is contemplated that the portion of the external surface of the conduit 10 along which the plurality of transducers 20 are positioned can have a length of at least 2 meters in the flow direction. In this aspect, each transducer 20 of the plurality of transducers can comprise means for sensing the velocity of fluid flow therethrough the conduit 10 in the flow direction.

Additionally, each transducer 20 of the plurality of transducers can further comprise means for sensing the speed at which the plurality of sound waves are propagating therethrough the fluid. It is contemplated that each transducer 20 can comprise a microphone for detecting sound within the conduit 10 proximate the transducer.

In a further aspect, each transducer 20 of the plurality of transducers can be positioned in a spaced position relative to a predetermined reference point on the external surface of the conduit 10. In this aspect, the spaced position can correspond to the longitudinal distance between the transducer 20 and the reference point.

As one having ordinary skill in the art will appreciate, each transducer 20 of the plurality of transducers can be configured to detect sound waves propagating therein the conduit 10 in a linear fashion relative to the flow of the fluid therethrough the conduit. It is contemplated that each transducer 20 of the plurality of transducers can be configured to also detect sound waves other than the sound waves propagating therein the conduit 10, including, for example and without limitation, ambient sound waves.

As discussed herein, it is further contemplated that the system described herein can be used to analyze the plurality of sound waves to identify the sound waves that are required for measurement of the flow velocity and the speed of sound therein the conduit 10. In one aspect, the plurality of transducers 20 can comprise, for example and without limitation, electret transducers, piezoelectric transducers, fiber optic transducers, laser transducers, liquid transducers, Micro-Electrical Mechanical System (MEMS) transducers, and the like. However, it is contemplated that any transducer that is capable of detecting a sound wave and converting the sound wave into an electrical signal can be used in the system described herein.

In an additional aspect, the system for measuring the superposition of the plurality of sound waves can comprise means for modeling the superposition of the plurality of sound waves as they propagate therein the conduit 10. In this aspect, the means for modeling the superposition can be in communication with each transducer 20 of the plurality of transducers.

In a further aspect, the means for modeling the superposition of the plurality of sound waves can be configured to receive a data set therefrom each transducer 20 indicative of the sensed velocity of fluid flow therethrough the conduit 10 in the flow direction F and the sensed speed at which the sound waves are propagating therethrough the fluid. In an additional aspect, the means for modeling the superposition of the plurality of sound waves can be configured to assign a position value to the data set indicative of the spaced position of the transducer which generated the data set. In still another aspect, the means for modeling the superposition of the plurality of sound waves can be configured to store an array of data sets and their corresponding position values. As one having ordinary skill in the art will appreciate, the array of data sets can be used to determine the speed of the plurality of sound waves and the velocity of the fluid at a given position. It is contemplated that, upon storage of a selected number of data sets, the means for modeling the superposition can be configured to process the array of data sets to produce a model of the superposition of the plurality of sound waves as they propagate therein the conduit 10.

In one aspect, it is contemplated that each sound wave of the plurality of sound waves can be generated at any position therein the conduit 10 without affecting the functionality of the system described herein. It is further contemplated that the phase, frequency, and amplitude of each sound wave of the plurality of sound waves does not affect the functionality of the system described herein.

As described above, ambient sound can interfere with flow measurements of a sound wave within a conduit by combining with the sound wave to create a resultant waveform that has a phase that is dependent upon the relative positions of the source of the sound wave. Because the interference of the ambient sound cannot be removed, the two different phase components of the resultant waveform must be measured directly in order to accurately model the phase of the sound wave. The two different phase components of the resultant waveform can be measured directly by employing a two-dimensional Fourier analysis. Typically, a two-dimensional Fourier analysis is performed on a signal with two time components:

$$Ψ ( {t}_{a} , {t}_{b} ) = {\sum }_{i}^{ } {\sum }_{j}^{ } Aij e [ {ω}_{i} {t}_{a} + {ω}_{j} {t}_{b} ] .$$

By performing the two-dimensional fast Fourier transform (2DFFT), all of the coefficients Aᵢⱼ can be found, thereby indicating the presence of the ω_{i or j} frequencies. It is specifically contemplated that the 2DFFT can be used to separate and model the two phase components of the resultant waveform.

Generally, the result of two arbitrary waves of the same frequency flowing through a fluid within a conduit and arriving from two different points in space, one wave traveling against the flow and the other traveling with the flow, is given by the following relationship:

$${Ψ}_{s} = A {e}^{[ ω ( t - \frac{x}{c + v} ) ]} + B {e}^{[ ω ( t + \frac{x}{c - v} ) ]} ,$$

wherein:
Ψ_{S}=the superposition resulting from two sound waves, one wave propagating with the flow of the fluid in the conduit and one propagating against the flow of the fluid in the conduit,
t=time,
x=horizontal position,
ω=frequency of the sound waves,
c=speed at which the plurality of sound waves propagate therethrough a fluid,
v=flow velocity of the fluid therethrough the conduit,
A=amplitude of one sound wave, and
B=amplitude of a second sound wave.

Generally, the result of two arbitrary waves of the same frequency flowing through a fluid within As one having ordinary skill in the art will appreciate, this relationship can be rearranged in the following wave equation:

$${Ψ}_{s} ( t , x ) = A {e}^{[ ω t - \frac{ω}{c + v} x ]} + B {e}^{[ ω t + \frac{ω}{c - v} x ]} ,$$

wherein
Ψ_{S}=the superposition resulting from two sound waves, one wave propagating with the flow of the fluid in the conduit and one propagating against the flow of the fluid in the conduit,
t=elapsed time since generation of the plurality of sound waves,
x=horizontal position relative to the reference position,
ω=frequency of the plurality of sound waves,
c=speed at which the plurality of sound waves propagate therethrough the fluid,
v=flow velocity of the fluid therethrough the conduit along the flow direction,
A=amplitude of the first sound wave, and
B=amplitude of the second sound wave.

In one aspect, the plurality of sound waves can comprise a first sound wave and a second sound wave. In this aspect, the first sound wave can propagate in the direction of flow, and the second sound wave can propagate opposite the direction of flow. As one having ordinary skill in the art will appreciate, the first sound wave and the second sound wave can be modeled using the above wave equation.

As depicted in FIG. 8, the result of a 2DFFT on the wave equation is two peaks in a three dimensional space (frequency, inverse length and amplitude). One peak corresponds to the first sound wave of amplitude A and the other peak corresponds to the second sound wave of amplitude B. Specifically, the 2DFFT can separate the negative and positive components of the resultant waveform. Therefore, for the wave equation modeling the first sound wave and the second sound wave, the peak in the negative half of the spatial spectrum and having an amplitude A corresponds to the first sound wave. Similarly, the peak in the positive half of the spatial spectrum and having an amplitude B corresponds to the second sound wave. In one aspect, the first sound wave can be generated upstream from the reference position and the second sound wave can be generated downstream from the reference position.

Accordingly, it is contemplated that the means for modeling the superposition of the plurality of sound waves can process the array of data sets by performing a two-dimensional fast Fourier transform on the array of data sets to calculate the values of A and B in the wave equation, as described herein. In an additional aspect, the means for modeling the superposition of the plurality of sound waves can comprise a computer having a processor. In this aspect, the processor can comprise an analog-to-digital converter for processing the data sets received therefrom the plurality of transducers 20.

In one aspect, the plurality of sound waves can comprise a first sound wave and a second sound wave. In this aspect, the first sound wave can propagate in the direction of flow, and the second sound wave can propagate opposite the direction of flow. As one having ordinary skill in the art will appreciate, the first sound wave and the second sound wave can be modeled using the above wave equation.

In another aspect, the analog-to-digital converter can process the data sets at a sample rate. In this aspect, it is contemplated that the sample rate of the analog-to-digital converter can be about 0.1 data sets per second. However, as one having ordinary skill in the art will appreciate, the sample rate can be higher or lower depending on the performance of the components of the system, as well as the number of transducers. Additionally, as one having ordinary skill in the art will further appreciate, the sample rate can be determined with reference to the maximum frequency of sound discernable therein the conduit.

In one exemplary aspect, and not meant to be limiting, in order to adequately perform the 2DFFT on the wave equation, the plurality of transducers 20 can comprise 2^{N} transducers, wherein N is greater or equal to 3, greater or equal to 4, and preferably is greater or equal to 5. In one aspect, the plurality of transducers 20 can comprise 32 transducers (N=5). In another aspect, the plurality of transducers 20 can comprise 64 transducers (N=6). In still another aspect, the plurality of transducers 20 can comprise 128 transducers (N=7). In a further aspect, the plurality of transducers 20 can comprise 256 transducers (N=8). As one having ordinary skill in the art will appreciate, the accuracy of the special component of the model can be improved by increasing the number of transducers in the system. As one will further appreciate, the accuracy of the time component of the model can be increased by acquiring additional data from the plurality of transducers 20.

In an additional aspect, each transducer 20 of the plurality of transducers can be longitudinally spaced from adjacent transducers by a separation length. In this aspect, the separation length of the transducers 20 can be related to the sample rate of the analog-to-digital converter and the speed at which the plurality of sound waves are propagating therethrough the fluid. The relationship between sample rate, separation length, and speed of the sound waves can be represented by the wave equation

$$Ψ = e {[}^{ω ( t \pm \frac{x}{c \pm v} )} ] .$$

In one aspect, it is contemplated that the steps in time between collection of data sets can be substantially the same as the relationship between (x/c). As one having ordinary skill in the art will appreciate, the steps in time can be represented by the following relationships:

$$Δ t = \frac{1}{sample rate} = \frac{Δ x}{c}$$

$$Δ x = \frac{c}{sample rate} .$$

Using these relationships, and with reference to FIG. 6, the components of the system can be used to calculate an appropriate separation length 22 of the transducers 20. In one aspect, the separation length 22 can be between about 0.5 inches and 3.5 inches, more preferably between about 1.0 and 3.0 inches, and most preferably between about 1.5 and 2.5 inches. However, as one having ordinary skill in the art will appreciate, the more transducers there are in the system, the smaller the separation length can be. As one will further appreciate, the shorter the portion of the external surface of the conduit along which the transducers are positioned, the smaller the separation length can be. Specifically, the separation length 22 can be selectively reduced to accommodate additional transducers 20 and to improve the accuracy of the model produced by the system. In another aspect, it is contemplated that the separation length 22 can be substantially inversely proportional to the sample rate. Therefore, in this aspect, the separation length 22 will be proportionally decreased as the sample rate increases. In particular, if the plurality of sound waves comprises a plurality of high-frequency sound waves, the sample rate can be increased, thereby leading to a decrease in separation length. Additionally, as the speed of sound (c, as shown in the above equation) associated with the fluid therein the conduit decreases, the separation length will be proportionally decreased.

In a further aspect, the plurality of transducers 20 can be detachably mountable thereon the external surface of the conduit 10. As one having ordinary skill in the art will appreciate, the plurality of transducers can be mounted thereon the external surface using any conventional means commonly known in the art, for example and without limitation, suction means, temporary binders, clamping means, fixation means and the like. In this aspect, the plurality of transducers 20 can be interconnected to form a substantially linear array of transducers. As one having ordinary skill in the art will appreciate, the substantially linear array of transducers 20 can permit movement of the plurality of transducers while maintaining a desired separation length between adjacent transducers.

In use, a method of using the system described herein can comprise positioning the plurality of transducers 20 substantially parallel to the flow direction F along at least a portion of the external surface of the conduit 10. In an additional aspect, each transducer 20 of the plurality of transducers can be positioned in a spaced position relative to the predetermined reference point on the external surface of the conduit 10.

In another aspect, the method can comprise receiving at least one data set therefrom each transducer 20 indicative of the sensed velocity of fluid flow therethrough the conduit 10 in the flow direction F and the sensed speed at which the sound waves are propagating therethrough the fluid. In an additional aspect, the method can comprise assigning a position value to each data set indicative of the spaced position of the transducer which generated the data set. In a further aspect, the method can comprise storing an array of data sets and their corresponding position values. In still a further aspect, the method can comprise processing the array of data sets to produce a model of the superposition of the plurality of sound waves as they propagate therein the conduit 10.

In an additional aspect, the plurality of sound waves can comprise a first sound wave and a second sound wave, as described herein. In this aspect, the step of processing the array of data sets can comprise modeling the superposition of the plurality of sound waves using the wave equation

$${Ψ}_{s} ( t , x ) = A {e}^{[ ω t - \frac{ω}{c + v} x ]} + B {e}^{[ ω t + \frac{ω}{c - v} x ]} ,$$

wherein:
Ψ_{S}=the superposition resulting from the combination of the plurality of sound waves,
t=elapsed time since generation of the plurality of sound waves,
x=horizontal position relative to the reference position,
ω=frequency of the plurality of sound waves,
c=speed at which the plurality of sound waves propagate therethrough the fluid,
v=flow velocity of the fluid therethrough the conduit along the flow direction,
A=amplitude of the first sound wave, and
B=amplitude of the second sound wave.

In a further aspect, the step of processing the array of data sets can comprise performing a two-dimensional fast Fourier transform on the array of data sets to calculate the values of A and B in the wave equation.

### Examples

In one experimental example, 64 transducers as described herein were positioned along the external surface of the conduit. Given this sample size, the theoretical result was predicted as follows. All frequencies of the sound waves were assumed to be present in a frequency domain of 0 Hz to 5000 Hz, and the speed of sound within the fluid was assumed to be 350 m/s. Based on these assumptions, the separation length between the transducers was expected to be approximately 0.035 m (1.378″). For ease of construction, and as demonstrated in FIG. 6, a separation length of 2.00 inches was selected. After applying these assumptions, a wave equation modeling the sound waves was produced. The 2DFFT based on the theoretical wave equation is depicted in FIG. 8B.

The experimental result was produced by generating a 3000 Hz sound wave in the flow direction therethrough the fluid in the conduit.

A computer having a processor was provided to model the superposition of the plurality of sound waves. As the sound waves traveled therein the conduit, the computer received data sets from the transducers at a sample rate of 10,000 samples per second and assigned position values to each data set. The computer stored these data sets and their corresponding position values in an array. The computer continued to receive data sets until a selected number of data sets had been stored. Upon storage of the selected number of data sets, a model of the superposition of the plurality of sound waves was produced in the form of the wave equation described herein. After the experimental model of the superposition of the plurality of sound waves was produced, a 2DFFT was performed. The 2DFFT based on the experimental wave equation is depicted in FIG. 8A. As one having ordinary skill in the art will appreciate, the experimental and theoretical depictions of the 2DFFT substantially match one another.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A system for measuring the superposition of a plurality of sound waves propagating therein a conduit containing a fluid, the conduit having an external surface, wherein the fluid flows therethrough the conduit in a flow direction, and wherein at least one sound wave of the plurality of sound waves is generated by the fluid flowing therethrough the conduit, the system comprising:
a plurality of transducers positioned substantially parallel to the flow direction along at least a portion of the external surface of the conduit, wherein each transducer of the plurality of transducers comprises means for sensing the velocity of fluid flow therethrough the conduit in the flow direction, wherein each transducer of the plurality of transducers further comprises means for sensing the speed at which the plurality of sound waves are propagating therethrough the fluid, and wherein each transducer of the plurality of transducers is positioned in a spaced position relative to a predetermined reference point on the external surface of the conduit, the spaced position corresponding to the longitudinal distance between the transducer and reference point;
means for modeling the superposition of the plurality of sound waves as they propagate therein the conduit, wherein the means for modeling the superposition is in communication with each transducer of the plurality of transducers, and wherein the means for modeling the superposition is configured to:
receive a data set therefrom each transducer indicative of the sensed velocity of fluid flow therethrough the conduit in the flow direction and the sensed speed at which the sound waves are propagating therethrough the fluid;
assign a position value to the data set indicative of the spaced position of the transducer which generated the data set; and
store an array of data sets and their corresponding position values,
wherein, upon storage of a selected number of data sets, the means for modeling the superposition is configured to process the array of data sets to produce a model of the phases of the plurality of sound waves as they propagate therein the conduit.

2. The system of claim 1, wherein the plurality of sound waves comprises two sound waves.

3. The system of claim 2, wherein plurality of sound waves comprises a first sound wave and a second sound wave.

4. The system of claim 3, wherein the superposition of the plurality of sound waves is modeled using a wave equation
$${Ψ}_{s} ( t , x ) = A {e}^{[ ω t - \frac{ω}{c + v} x ]} + B {e}^{[ ω t + \frac{ω}{c - v} x ]} ,$$
wherein:
Ψ_{S}=the superposition resulting from the combination of the plurality of sound waves,
t=elapsed time since generation of the plurality of sound waves,
x=horizontal position relative to the reference position,
ω=frequency of the plurality of sound waves,
c=speed at which the plurality of sound waves propagate therethrough the fluid,
v=flow velocity of the fluid therethrough the conduit along the flow direction,
A=amplitude of the first sound wave, and
B=amplitude of the second sound wave.

5. The system of claim 4, wherein the means for modeling the superposition of the plurality of sound waves processes the array of data sets by performing a two-dimensional fast Fourier transform on the array of data sets to calculate the values of A and B in the wave equation.

6. The system of claim 1, wherein the plurality of transducers comprises 64 transducers.

7. The system of claim 1, wherein the plurality of transducers comprises 128 transducers.

8. The system of claim 1, wherein each transducer of the plurality of transducers is longitudinally spaced from adjacent transducers by a separation length.

9. The system of claim 8, wherein the separation length is between about 0.5 inches and 3.5 inches.

10. The system of claim 8, wherein the separation length is between about 1.0 and 3.0 inches.

11. The system of claim 8, wherein the separation length is between about 1.5 and 2.5 inches.

12. The system of claim 1, wherein the means for modeling the superposition of the plurality of sound waves comprises a computer having a processor.

13. The system of claim 12, wherein the processor comprises an analog-to-digital converter for processing the data sets received therefrom the plurality of transducers, and wherein the analog-to-digital converter processes the data sets at a sample rate.

14. The system of claim 13, wherein the sample rate of the analog-to-digital converter is about 0.1 data sets per second.

15. The system of claim 1, wherein the plurality of transducers are detachably mountable thereon the external surface of the conduit.

16. The system of claim 15, wherein the plurality of transducers are interconnected to form a substantially linear array of transducers.

17. A method for measuring the superposition of a plurality of sound waves propagating therein a conduit containing a fluid, the conduit having an external surface, wherein the fluid flows therethrough the conduit in a flow direction, and wherein at least one sound wave of the plurality of sound waves is generated by the fluid flowing therethrough the conduit, the method comprising:
providing a plurality of transducers positioned substantially parallel to the flow direction along at least a portion of the external surface of the conduit, wherein each transducer of the plurality of transducers comprises means for sensing the velocity of fluid flow therethrough the conduit in the flow direction, wherein each transducer of the plurality of transducers further comprises means for sensing the speed at which the plurality of sound waves are propagating therethrough the fluid, and wherein each transducer of the plurality of transducers is positioned in a spaced position relative to a predetermined reference point on the external surface of the conduit, the spaced position corresponding to the longitudinal distance between the transducer and reference point;
receiving a data set therefrom each transducer indicative of the sensed velocity of fluid flow therethrough the conduit in the flow direction and the sensed speed at which the sound waves are propagating therethrough the fluid;
assigning a position value to the data set indicative of the spaced position of the transducer which generated the data set;
storing an array of data sets and their corresponding position values; and
processing the array of data sets to produce a model of the superposition of the plurality of sound waves as they propagate therein the conduit.

18. The method of claim 17, wherein the plurality of sound waves comprises a first sound wave and a second sound wave, and wherein the step of processing the array of data sets comprises modeling the superposition of the plurality of sound waves using a wave equation
$${Ψ}_{s} ( t , x ) = A {e}^{[ ω t - \frac{ω}{c + v} x ]} + B {e}^{[ ω t + \frac{ω}{c - v} x ]} ,$$
wherein:
Ψ_{S}=the superposition resulting from the combination of the plurality of sound waves,
t=elapsed time since generation of the plurality of sound waves,
x=horizontal position relative to the reference position,
ω=frequency of the plurality of sound waves,
c=speed at which the plurality of sound waves propagate therethrough the fluid,
v=flow velocity of the fluid therethrough the conduit along the flow direction,
A=amplitude of the first sound wave, and
B=amplitude of the second sound wave.

19. The method of claim 18, wherein the step of processing the array of data sets comprises performing a two-dimensional fast Fourier transform on the array of data sets to calculate the values of A and B in the wave equation.
